(19) United States
(12) Patent Application Publication
(10) Pub. No.: US 2023/0280465 A1
(43) Pub. Date: Sep. 7, 2023

(54) Computer-Implemented Method for Determining the Validity of an Estimated Position of a Vehicle

(71) Applicant: Bayerische Motoren Werke Aktiengesellschaft, Muenchen (DE)

(72) Inventors: Sebastian GRUENWEDEL, Ulm (DE); Pascal MINNERUP, Unterschleissheim (DE); Barbara ROESSLE, Boerslingen (DE); Maxi WINTER, Muenchen (DE); Martin ZEMAN, Vestec (CZ)

(21) Appl. No.: 18/016,048

(22) PCT Filed: Jun. 29, 2021
(86) PCT No.: PCT/EP2021/067885

§ 371 Date: Jan. 13, 2023

(30) Foreign Application Priority Data
Jul. 15, 2020 (DE) 10 2020 118 629.0

(51) Int. Cl. G01S 17/89; G06T 7/73; G01S 17/86; G01S 7/48; G01S 13/89

(52) U.S. Cl. CPC G01S 17/89; G06T 7/73; G01S 17/86; G01S 7/4808; G01S 13/89; G06T 2207/30252

(57) ABSTRACT

A method for determining the validity of an estimated position of a vehicle includes receiving the estimated position; receiving sensor information relating to a vehicle environment; detecting a number of first features in the digital map and a number of second features in the sensor information, wherein the features indicate at least one object beside a road; grouping the first features into a number of first feature groups and grouping the second features into a number of second feature groups; rejecting first and/or second feature groups; assigning at least some of the first feature groups which have not been rejected to a particular second feature group which has not been rejected; and determining the validity of the estimated position based on a comparison of positions of a number of the first feature groups which have not been rejected with positions of the respectively assigned second feature groups.

### BACKGROUND AND SUMMARY OF THE INVENTION

The invention relates to a computer-implemented method for determining the validity of an estimated position of a vehicle. In particular, the invention relates to protecting the determination of a vehicle position against possible errors. In this respect, reference is also made to German patent application 10 2019 133 316.4, the content of which is hereby incorporated into this application.

Furthermore, the invention relates to a processing device and a computer program for carrying out such a method and a computer-readable (memory) medium containing instructions for carrying out such a method.

A vehicle may have a driving assistant set up to influence longitudinal or lateral control of the vehicle. For example, a lane assistant may be set up to keep the vehicle between lane markings. The markings can for example be scanned by way of a camera and automatically detected.

Many driving assistants require knowledge of the exact position of the vehicle. The position can be determined in the longitudinal and/or lateral direction and relative to a predetermined reference point. An absolute geographical position can, for example, be determined relative to a predetermined geodetic reference system such as WGS84. A relative position of the vehicle can be indicated, for example, in the lateral direction relative to a detected lane marking.

The determination of the position of the vehicle is usually subject to a series of errors and inaccuracies. Sensors provide, for example, noisy and/or incorrect information or can occasionally fail completely. Different measurement conditions or complex processing heuristics led to differently precise or reliable determinations. If the vehicle is controlled on the basis of such a determined position, the safety of the vehicle or an occupant can be endangered.

In order to enable the most reliable determination of the position of the vehicle, one can, for example, use methods involving a localization step and a validation step.

As part of the localization, a vehicle position is estimated. For example, estimating the vehicle's position can be carried out with reference to a digital map using data from a satellite navigation system (for example GPS or DGPS).

In the context of the validation, the validity of the position estimation is assessed by comparing the estimated vehicle position with sensor-detected data of the vehicle environment. Here, for example, by way of a comparison of detected data of a LiDAR sensor with data of a provided map, which indicates expected features, which are detectable by the LiDAR sensor in principle, it can be checked whether the estimated position is plausible. If features detected by the LiDAR sensor are sufficiently consistent with the expected features, the estimated vehicle position is confirmed (i.e. positively validated) by the validation. On the other hand, it may be provided, for example, that the estimated position is explicitly not confirmed if the comparison of detected features and expected features results in a deviation from the estimated position that exceeds a predetermined value (for example 2 meters).

Validation can be carried out, for example, by way of an electronic data processing device. For example, the above-mentioned LiDAR sensor may have an associated software component referred to as a (LiDAR) validator as an information source for validation at a logical or data technology processing level.

In order to ensure a reliable position determination overall, it is desirable to keep the statistical uncertainties associated with the validation itself as low as possible.

To determine the uncertainty of a single validator, a statistical test can be performed. For example, on the basis of available sensor data collected during a physical vehicle journey at a point in time, it is checked whether the validator, which is provided with a number of (intentionally) incorrect position estimates, rejects these on the basis of the sensor data. By using sensor data that can be detected at several different points in time, meaningful statistics can be compiled.

It is particularly desirable that the number of false positives of a validator, i.e. of positive confirmations of an actually false position by the validator, is small. In other words, when the validator is asked to assess the validity of an incorrect position estimate, it is very unlikely that it will confirm that position estimation.

A challenge related to the uncertainty of validation is that an environment sensor, such as a LiDAR sensor, will generally perceive only some of the “expected” features in the vehicle environment according to a digital map. In addition, it may happen that the (possibly few) recorded features, which are therefore available for comparison, fit several different features in the map. There can therefore sometimes be an ambiguity (i.e. an equivocation) in the assignment of recorded and expected features, which from the validator's point of view translates into an ambiguity of the vehicle position.

Based on this, an object underlying the invention is to propose an improved determination of the validity of an estimated position of a vehicle. This object is achieved by the claimed invention.

It should be noted that additional features of a claim which is dependent on an independent claim, without the features of the independent claim or only in combination with a subset of the features of the independent claim, may form a separate invention which is independent of the combination of all the features of the independent claim and which may be made the subject of an independent claim, a divisional application or a subsequent registration. The same applies to technical teachings described in the description which may form an invention independent of the features of the independent patent claims.

A first aspect of the present invention relates to a computer-implemented method for determining the validity of an estimated position of a vehicle.

One step of the method is receiving a digital map.

For example, the digital map can be used by a digital processing device and/or by a logical software module (which can be referred to as a validator, for example). The digital map may be, for example, a highly accurate digital map, which in particular represents a roadway including lanes and objects in the vehicle environment, such as obstacles at the edge of the roadway, for example.

Receiving the digital map can include, for example, in particular the loading of a relevant map section of such a map, wherein the map section contains map information about the vehicle environment.

The digital map may be provided, for example, by a map memory which may be arranged in the vehicle. Alternatively, the digital map can also be transmitted to the vehicle from outside the vehicle, for example from a server, wherein the transmission preferably takes place via a wireless communication interface.

The digital map may, for example, be based at least in part on the sensor-detected data recorded during one or more reconnaissance trips of a reconnaissance vehicle. An environment sensor system used here can, for example, contain a receiver of a global satellite navigation system (for example GPS or DGPS), one or more optical cameras, one or more RADAR sensors and/or one or more LiDAR sensors.

Accordingly, the digital map may contain multiple layers, wherein, for example, one layer is based on data of a global satellite navigation system, another layer is based on optical camera data, and another layer is based on LiDAR data. The different layers can contain features that can be detected by way of the respective sensors.

In particular, the digital map may contain two-dimensional information. This means that for example in particular information about a course of a roadway including lanes in a plan view can be taken from the digital map, which makes it possible to locate the vehicle with respect to a current lane.

Optionally, the digital map may also contain three-dimensional information in some embodiments. Accordingly, height information of objects may be provided. For example, in addition to the course of a guard rail in a two-dimensional plan view, the digital map can also include data about the height of the guard rail. Such a map with a 2D top view and some additional height information is often referred to as 2.5D. Alternatively, the map can be fully 3D.

A further step of the method is receiving an estimated position of the vehicle, wherein the estimated position is a position in the digital map or is (preferably uniquely) assignable to a position in the digital map.

According to an embodiment, an extended method may additionally include a step of estimating the position of the vehicle, wherein this step can be carried out by way of an electronic processing device.

Estimating a position in the context of this description means advance determination of the position. This may or may not necessarily include a statistical estimation operation in the mathematical sense.

The position estimation can still be subject to an uncertainty, which may only be reduced to an acceptable level (for example from safety aspects) by the subsequent validation.

The estimation of the vehicle position can be carried out, for example, in relation to map information, i.e. the map position at which the vehicle is located can be estimated, for example.

For example, the estimation of the vehicle position can be carried out using data of a satellite navigation system (for example GPS or DGPS). In addition or alternatively, sensor data provided by an environment sensor system of the vehicle can also be used, for example. The environment sensors may include one or more RADAR and/or LiDAR sensors and/or one or more cameras, for example.

According to one embodiment, the vehicle position is estimated using odometry data. The odometry data can, for example, quantify a movement relative to a previously occupied position and can be determined on the basis of signals produced by rotation rate sensors on wheels of the vehicle, for example.

The position estimation can be carried out in particular relative to one or more lane boundaries and for example make a statement about which of several lanes the vehicle is driving on.

For example, in order to ensure sufficient safety during autonomous or highly automated driving, it is necessary that the vehicle position relative to the surrounding lanes is reliably determined. It is therefore desirable, in the context of an overall safety concept, to determine the lane in which the vehicle is located with a very high statistical assurance. In other words, a high level of localization reliability is desirable, especially with regard to the lane.

In order to ensure the integrity of the vehicle position estimation, it is validated. In other words, the validity (i.e. the effectiveness) of the estimated position of the vehicle is determined. The further method steps described below are to be understood in this context.

In accordance with the steps described in more detail below, the validation of the estimated vehicle position is carried out using information contained in the digital map and information provided by an environment sensor system of the vehicle. The environment sensor system preferably comprises several different types of sensors and/or statistically independent sensors, such as one or more LiDAR sensors and/or one or more RADAR sensors and/or one or more optical cameras.

The validation may be carried out by way of a processing device. The respective environment sensor or sensors used for validation may have one or more software components referred to as “validators” assigned to them at a logical or data-technical processing level, for example.

Reliable lateral localization, including a determination of the lane in which the vehicle is travelling, is generally particularly important. This can be checked, for example, by way of one or more validators. A validator that validates a lateral localization can, for example, also check longitudinal localization (possibly with lower accuracy requirements compared to lateral localization). For example, one or more validators can also be provided, which check that the vehicle is generally on the correct street.

In general, it is preferred that several different validators check whether each associated sensor data item confirms an estimated position or not. For instance, a first validator based on LiDAR data can make a statement about whether the vehicle is in a certain lane according to the estimated position. In addition, a second validator, for example based on camera lane detection, can provide a corresponding evaluation of the position estimation. If both validators confirm the position estimation, there is generally a higher degree of certainty that the position estimation is correct, compared to a situation in which only the confirmation by one validator is available or compared to a situation in which one or even both validators explicitly do not confirm the position estimation.

A non-confirmation of the position estimation by a validator can, for example, occur in cases in which the values available to the validator are not sufficient to reliably confirm the position and/or if an actual deviation in the position is detected.

The validation concept is therefore based on advantageous embodiments on a series of preferably statistically independent validators that can confirm a position estimation. If sufficient validators confirm an estimation, the position estimation is considered safe.

With such a validation concept, the determined position of the vehicle can, in principle, lie arbitrarily safely within a predetermined error range. If, for example, the position of the vehicle is validated on the basis of three validators, and probabilities for an erroneous validation by the individual validators are determined in such a way that only one out of 1000 cases is erroneously validated by a validator, a position of the vehicle validated with a positive result may still be wrong in only one out of 1000*1000*1000=1 000 000 000 cases. For the purposes of this determination, it was assumed that the validators were independent of each other. The probability of an unnoticed erroneous determination of the vehicle position can be made so unlikely that the position can be determined with a certainty that satisfies the required safety of use. For example, the validation can thus ensure that the estimated position does not deviate from the actual position by more than 2 meters with a very high probability.

In accordance with the above, it is in principle desirable that the individual validators fail as rarely as possible. In this context, failure can mean in particular that a validator confirms a position estimate that is actually false (“false positive”). For example, it could lead to a safety-critical situation if, for example, a LiDAR-based validator, if applicable together with other validators, wrongly concludes that a position estimation is correct.

The method steps described below are intended to enable a validation of the estimated vehicle position, with which in particular the risk of such false positive reports is low.

A further step is the detection of a number of first features in the digital map, wherein the first features indicate at least one object next to a roadway.

The object or objects can be, for example, a guard rail, a grass edge, a street lamp, a tree or a building. In principle, all types of objects come into question, which at least in principle can also be detected by way of the vehicle's environment sensors. As part of the validation of the vehicle position, such objects serve as orientation points (landmarks).

The first features that indicate one or more such objects may be present, for example, in the form of data points of a data point cloud, wherein each data point corresponds to a position in the digital map. It is also conceivable that the digital map represents the object or objects primarily in the form of continuous structures, such as areas or lines, wherein these structures are translated into a point cloud for further processing by sampling.

In a further step, the first features are grouped into a number of first feature groups. This is done in such a way that all the first features that can be found in a respective area defined with regard to its longitudinal extent next to the roadway belong to a first feature group assigned to the respective area.

For example, several related areas can be defined, each of which extends along the roadway over a predetermined length (for example 1 meter). All first features that are in such an area can then be assigned to the same first feature group. As a result, several first feature groups are created, each containing the first features that are located in the respective assigned areas.

A further step is the reception of sensor information about an environment of the vehicle.

The sensor information can, for example, have been detected by way of a first sensor which is part of an environmental sensor system of the vehicle.

In general, the environment sensor system is set up to detect and provide information regarding the environment of the vehicle. The environment sensors can in particular include a camera, a depth camera, a radar sensor, a LiDAR-sensor or a similar sensor. Such a sensor preferably works contactlessly, for example by detecting electromagnetic waves or ultrasonic waves, and may be image generating.

In a preferred embodiment, the sensor information is produced by way of a LiDAR sensor.

A further step is the detection of a number of second features in the sensor information, wherein the second features indicate at least one object next to a roadway.

The second features, which indicate one or more such objects, may be present in the form of data points of a data point cloud, for example, wherein each individual data point for example displays a sensor-detected measuring point together with its position in relation to the vehicle. For example, such a data point cloud can be provided by a LiDAR scanner.

A further step is to group the second features into a number of second feature groups in such a way that all second features located in a respective area defined with regard to its longitudinal extent next to the roadway belong to a second feature group assigned to the respective area.

For example, as described above with reference to grouping the first features, several contiguous areas can be defined, each extending over a predetermined length (for example 1 meter) along the roadway. All the second features that are in such an area can then be assigned to the same second feature group. As a result, several second feature groups are created, each containing second features located in the respective assigned areas.

The division into areas, each of which has a defined longitudinal boundary, can be the same as that used when grouping the first features.

In the following, the areas mentioned above which extend longitudinally over a defined distance along the roadway are sometimes referred to as “buckets”. The division of the first and second features when grouped into feature groups based on the areas can also be illustrated in such a way that the features are put into different containers.

A further step is rejecting the first feature groups whose maximum lateral extent (i.e. a distance between a leftmost feature and a rightmost feature) exceeds a first predetermined value (for example 1 meter) and/or rejecting second feature groups whose maximum lateral extent has a second predetermined value, which is identical with the first value. In particular, all first or second feature groups whose lateral extent exceeds the first or second predetermined value can be rejected.

A further step is to assign at least some of the first feature groups that have not been rejected to a respective second feature group of features that have not been rejected.

In particular, such first and second feature groups, which correspond to each other in the sense that it may be that they describe the same object or parts of an object in the digital map or in the vehicle environment, can be assigned to each other. If, when grouping the first or second features, the same division of the digital map or a corresponding section of the sensor-detected vehicle environment into longitudinally delimited areas has been used, the mutually assigned feature groups can in particular correspond to each other in the sense that they are assigned to mutually corresponding areas.

A further step is to determine the validity of the estimated position of the vehicle on the basis of a comparison of positions of a number of the unrejected first feature groups with positions of the respective assigned second feature groups. The positions of the first and second feature groups are preferably compared in a common coordinate system, which has a fixed relationship to the digital map. The determination of the validity of the estimated position is thus carried out by comparing first features that are expected on the basis of the map information and second features that are detected by way of the environment sensors.

In accordance with the foregoing, the validity of the estimated position may be, for example, determined in such a way that, based on the (hypothetical) assumption that the estimated position was correct, the positions of the number of the first feature groups are compared with the positions of the respective assigned second feature groups in a common coordinate system.

It may be provided that the estimated position is confirmed (i.e. positively validated) if the positions of all mutually assigned feature groups differ by less than a predetermined distance (for example 50 cm or 1 m).

According to an embodiment variant, different predefined distances can also be provided as criteria for the evaluation of position deviations in the longitudinal or lateral direction. For example, it may be provided that the estimated position is confirmed if a lateral distance between the mutually assigned feature groups is not greater than 50 cm and if a longitudinal distance between the mutually assigned feature groups is not greater than 1 meter.

The indication that it is one or more predetermined distances does not mean that they would not be changed manually or automatically according to an algorithm. Rather, it should be stated that the position comparison between the mutually assigned feature groups in the context of validation takes place in relation to a predetermined distance in this specific context. However, this does not rule out the possibility that the value of the distance can be usefully adjusted over time or for certain spatial areas or depending on other parameters.

According to a further embodiment, the decision as to whether the arrangement of the mutually assigned feature groups matches a position estimation can also be made on the basis of a statistical consideration. For example, it may be provided that the estimated position is confirmed if the positions of at least a defined proportion (such as at least 90%) of the mutually assigned feature groups differ by less than a predetermined distance (possibly differentiated by lateral and longitudinal direction, as described above).

An optional development also provides that the statistical analysis also takes into account a distance distribution. For example, it may be provided that as a prerequisite for a confirmation of the estimated position, at least 60% of the considered pairs of assigned first and second feature groups may not be more than 30 cm apart, and that at the same time at least 90% of the pairs may not be further than 60 cm apart.

It is also pointed out that in the context of the validation, the (possibly statistical) comparison of the positions of the mutually assigned feature groups can be carried out with reference to a certain set of feature groups, which can for example correspond to a currently considered map section. Thus, for example, a map section which extends over a length of 20-40 meters (longitudinal) along the roadway can be considered. For a defined length of the individual areas of 1 meter, this would result in a total of a maximum of 20-40 feature groups forming the basis of the comparison. For example, if 90% of these feature groups are in agreement (i.e. are not further apart by a predetermined distance), the estimated position is validated, as already explained above as an example.

It is also within the scope of the invention that in an optional further step it can first be checked whether after rejecting some first and/or second feature groups a sufficient number of feature groups that can be assigned to each other still remains. For example, it should be provided that the estimated position is not confirmed if only a number of mutually assignable feature groups remains that correspond to a length of less than 10 meters (or another predetermined distance) on the map. For example, it can be provided as a necessary condition for a confirmation of the position that the mutually assignable features must cover a length of roadway of at least 10 meters (or another predetermined distance).

The invention is based on the idea that the reliability of the validation of an estimated vehicle position can be improved and in particular that the probability of false confirmations can be reduced by specifically preventing such features from a digital map and/or from environment sensor data from being used for the determination of the validity of the position estimation, which could lead to ambiguities (i.e. equivocations) when comparing a digital map and environment sensor data.

According to embodiments of the invention, it is therefore provided that first and/or second feature groups, whose respective maximum lateral extent exceeds a predetermined value are rejected so that they are not used to determine the validity and cannot falsify the result.

This can, for example, affect laterally very widely extended objects at the edge of the roadway. Furthermore, several laterally spaced objects may be affected, which overlap in such a way that they have a common longitudinal reach. By including such objects in the validation in particular of an estimated lateral position, an undesirable ambiguity could arise. According to embodiments of the invention, features that correspond to such objects can be rejected, so that the potential ambiguity in determining the validity of the estimated position cannot occur.

In other words, the method provides for the determination of a subset of the object information available in the map data and in the environment sensor data, which cannot be used for a determination of the validity of the estimated position. The validation of the estimated position is then carried out only on the basis of the rest of the object information.

According to an advantageous embodiment, the method is carried out separately for features indicating objects on different sides of the roadway. In other words, on the one hand, all method steps are executed for features based on objects on the left side of the roadway, and independently thereof for features that indicate objects on the right side of the roadway. Accordingly, separate validators can be implemented at the software level, wherein one validator is based only on object information from the left edge of the roadway and a separate validator is based only on object information from the right edge of the roadway.

In this way, it can be prevented that ambiguities introduced by a certain type or arrangement of objects on one side of the roadway unnecessarily interfere with the exploitation of object information with respect to the other side of the roadway. It may happen, for example, that over a certain length of roadway objects on the right-hand side of the roadway are unsuitable for position validation. In such a case, however, it may be useful to use the object information on the left side of the roadway for validation.

For example, it may be provided that the result of the determination of the validity of the position estimation is positive overall if a first validator using object information from the right-hand side of the roadway confirms the position estimation and if at the same time a second validator containing object information from the left-hand side of the roadway does not give an indication, for example because not enough evaluable features are detected on the right-hand side of the roadway.

Furthermore, for example, it may be provided that the result of determining the validity of the estimated vehicle position is neutral (i.e. neither a confirmation nor a clear falsification is issued) if the first validator confirms the position estimation and the second validator explicitly does not confirm the position estimation (i.e. falsifies the position estimation).

It is also within the scope of the invention that for the above-described step of rejecting, the first features and/or the second features located in a respective area next to the roadway defined with regard to its longitudinal extent are additionally also considered as part of the first or second feature groups assigned to respective longitudinally adjacent areas. In other words, in this embodiment variant, the respective features for the step of rejecting are also placed in adjacent “buckets”. This virtually lengthens the corresponding objects to which the features refer, so to speak. For example, if areas (buckets) with a respective length of 1 meter are created, this results in a virtual extent of 2 meters. In this way a longitudinal measurement tolerance can be taken into account, for example.

According to an embodiment, the digital map and the sensor information each provide height information about the (first or second) features. Features whose height differs at least by a predetermined height difference are not assigned to the same feature group.

The feature height can therefore be used as a possible distinguishing feature, which can resolve a possible ambiguity. For example, a grass edge and a guard rail extending parallel to the edge of the roadway in the same area could be distinguished on the basis of height, so that they could not introduce an ambiguity which could affect the reliability of the validation of the estimated position.

In accordance with the foregoing, an algorithm used may therefore be based in particular on a 2D representation or on a 3D representation of the vehicle environment. A 2D representation can have the advantage that it requires fewer computing resources. In a 3D representation, the grouping of features can be used not only for each longitudinal position, but also for each height, so that if appropriate overall more features can be used for the validation.

The estimation and/or validation of the position of the vehicle can, for example, be carried out at least partially by way of machine learning. For instance, the estimation of the position and/or the validation of the position may be carried out by way of an artificial neural network or other machine learning system.

If machine learning is used, an adequate database and a suitable “ground truth” are necessary for good protection. As a data record, for example the data of test drives with millions of kilometers can be used. For test purposes, these data can be intentionally linked to incorrect position estimates that the LiDAR-based validator must reject, as well as to ground truth positions (for example received from a reference DGPS sensor), which the validator must confirm as correct.

The method can be further improved by determining a condition of the vehicle, i.e. estimating and validating in the manner proposed according to embodiments of the invention. A condition includes, in addition to the position of the vehicle, an orientation of the vehicle (for example an orientation relative to one or more lane boundaries). The position can be specified, for example, in Cartesian coordinates along a right-hand system of two or three axes and the orientation as the angle of rotation around these axes.

According to a second aspect of the invention a processing device is proposed, wherein the processing device is designed for carrying out a method according to the first aspect of the invention. Features or advantages of the method may accordingly be transferred to the processing device or vice versa.

The processing device can, for example, be part of a control system of the vehicle which comprises one or more processors (such as CPUs and/or GPUs) on which the necessary arithmetic operations to carry out the method take place.

Different processing devices may also be used, such as a dedicated processing device for estimating the position and another processing device for validating the position.

For example, the vehicle whose position is to be validated can have a processing device according to the second aspect.

The vehicle preferably comprises a drive motor and is a motor vehicle, in particular a roadway-bound motor vehicle. The motor vehicle can be controlled in the longitudinal direction, for example by influencing the drive motor or a braking device.

Preferably, the vehicle is set up for at least partially automated driving, up to for highly automated or even autonomous driving.

For example, a driving function of the vehicle can be controlled depending on the estimated and validated position. The driving function can in particular cause a longitudinal and/or lateral control of the vehicle, for example in the form of a speed assistant or a lane departure warning system. The estimated and validated position can be a safety-relevant parameter of the vehicle and can be measured, for example, in the longitudinal and/or lateral direction of the vehicle.

A third aspect concerns a computer program which includes instructions which, during the execution of the computer program by a processing device, cause it to carry out a method according to the second aspect of the invention.

A fourth aspect of the invention concerns a computer-readable (memory) medium comprising instructions which, when carried out by a processing device, cause it to carry out a method according to the first aspect of the invention.

It is understood that the processing device mentioned above in connection with the third and fourth aspects of the invention may in particular be a processing device according to the second aspect of the invention.

For example, the processing device may comprise a programmable microcomputer or microcontroller and the method may be in the form of a computer program product with program code. The computer program product may also be stored on a computer-readable data carrier.

The invention is now explained in more detail by way of exemplary embodiments and with reference to the accompanying drawings. In this case, the features and feature combinations mentioned in the description and/or shown in the drawings alone can be used not only in the combination specified in each case, but also in other combinations or on their own, without departing from the scope of the invention.

### BRIEF DESCRIPTION OF THE DRAWINGS

FIG. 1A shows schematically and by way of example a section of a digital map with a number of first features that indicate objects in the vicinity of a vehicle.

FIG. 1B shows schematically and by way of example a number of sensor-detected second features that indicate objects in the vicinity of the vehicle.

FIG. 2A shows the map section from FIG. 1A, based on an alternative grouping of the first features into feature groups.

FIG. 2B shows the sensor-detected second features from FIG. 1B, based on an alternative grouping of the second features in feature groups.

FIG. 3 shows a schematic flowchart of a computer-implemented method for determining the validity of an estimated vehicle position.

### DETAILED DESCRIPTION OF THE DRAWINGS

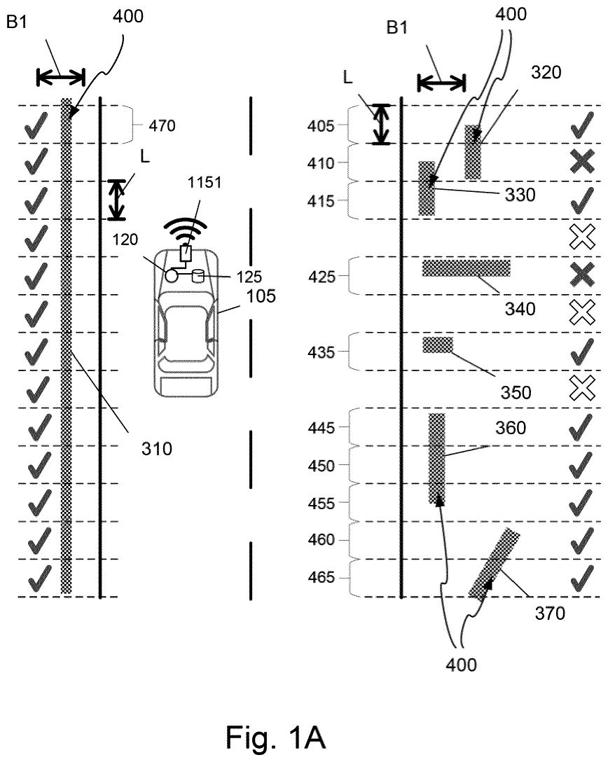

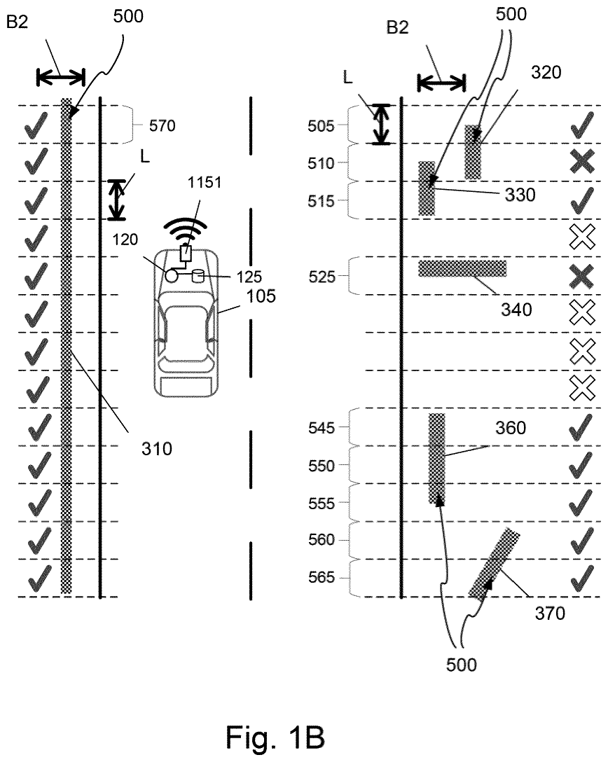

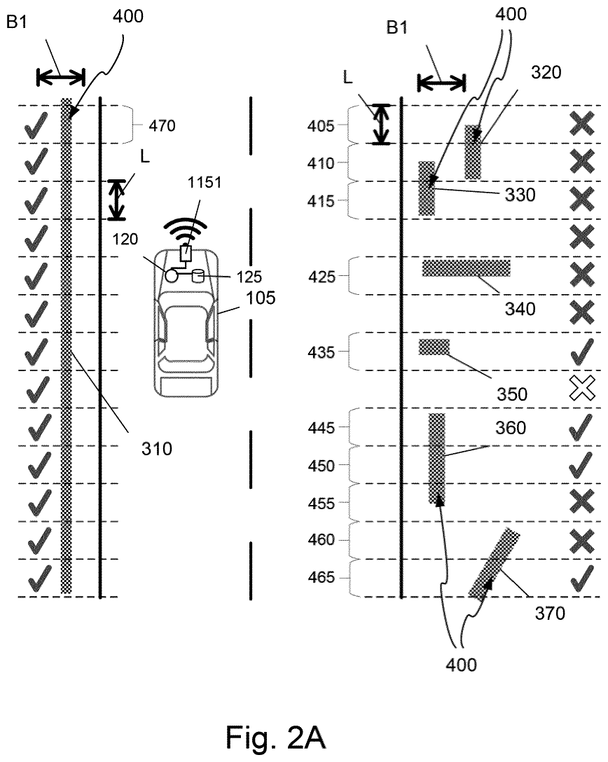

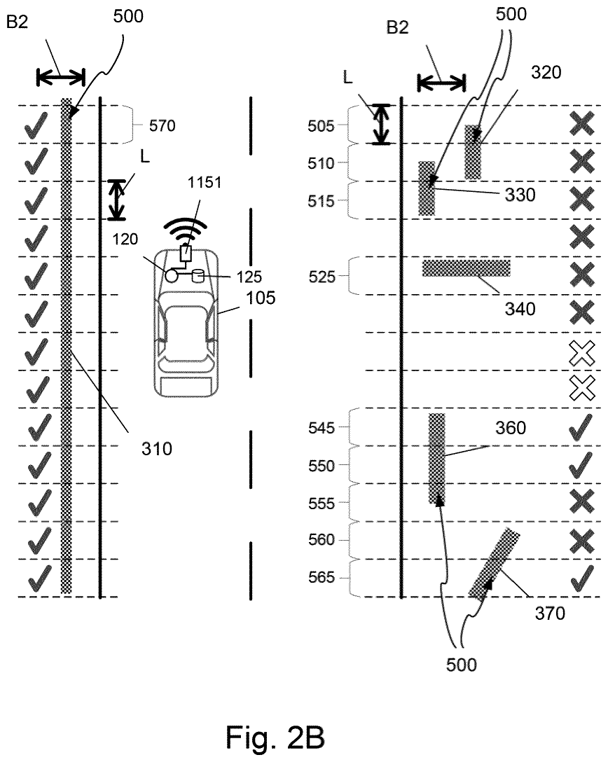

FIGS. 1A-2B refer to an example scenario in which the validity of an estimated position of a motor vehicle 105 is determined from objects 310-370 located next to a roadway.

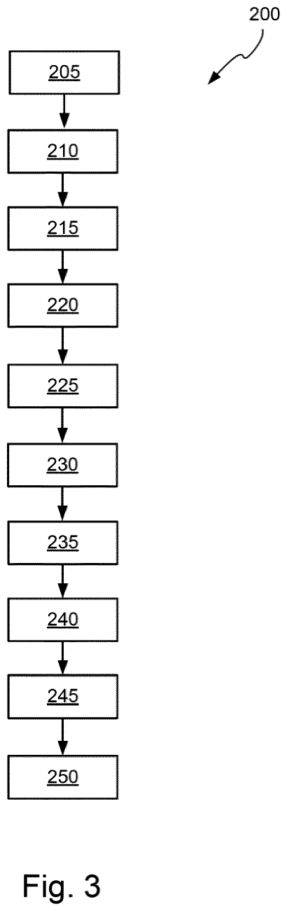

In the following, the invention is explained by way of example on the basis of this example scenario, wherein reference is made here to FIG. 3, which shows a schematic flowchart of a method 200 according to an embodiment of the invention.

The vehicle 105 is set up for automated driving. For this purpose, it must be able to determine its position, in particular relative to lane boundaries and objects in the vicinity of the vehicle. A driving function of the vehicle 105 can then be controlled automatically depending on the specific position. The driving function may, in particular, cause automatic longitudinal and/or lateral control of the vehicle 105.

The vehicle 105 is equipped with an environment sensor system, wherein in FIGS. 1A-2B only one environment sensor in the form of a LiDAR sensor 1151 is shown by way of example. In addition, the environment sensor system of the vehicle 105 may include, for example, one or more cameras and one or more RADAR sensors. In addition, a receiving device not explicitly shown in the figures for a global satellite navigation system and/or an odometer for providing odometry data may be provided.

Furthermore, a processing device 120 is arranged in the vehicle 105. For example, the processing device 120 may be part of a control system for the automated driving functions of the vehicle 105. In this case, the processing device 120 comprises one or more processors (such as CPUs and/or GPUs), on which the necessary arithmetic operations run to carry out a method 200 for determining the validity of an estimated position of a vehicle 105.

Steps of method 200 are schematically illustrated in FIG. 3. In the following, the individual method steps 205-250 are explained with reference to FIGS. 1A-2B by way of example.

In a step 205, a digital map is received by the processing device 120 or by a software module executed by the processing device 120. In the present exemplary embodiment, the digital map is provided by a digital map memory 125, which is arranged in the vehicle 105 and communicatively connected to the processing device 120.

Receiving the digital map specifically involves loading a relevant map section containing relevant map information about the vehicle environment. For example, the map section can cover a roadway length of 40 meters.

Some of the received map information is illustrated in FIG. 1A. The loaded map section therefore shows in particular a lane including lane boundaries and several objects 310, 320, 330, 340, 350, 360, 370, which according to the map information are located to the left and right of the roadway at the edge of the roadway.

For example, among the objects may be a guard rail 310 extending longitudinally along the roadway, as shown on the left side in FIG. 1A. The schematically represented objects 320-370 located to the right of the roadway, can, for example, be sections of a guard rail, a grass edge, a noise barrier or the like. Also trees, bushes, street lamps, bridge piles, etc. can be among the objects 320-370.

The digital map can, for example, be based at least partly on sensor-detected data recorded during one or more reconnaissance trips of a reconnaissance vehicle of a service provider of the digital map. The digital map can, for example, include several layers, wherein the various layers contain features which can be detected by different environment sensors of the vehicle 105.

In the following, it is assumed that among the objects 310-370 shown in the digital map according to FIG. 1A are at least some objects that can in principle be detected in the vehicle environment by way of the LiDAR sensor 1151.

In a further step 210 an estimated position of the vehicle 105 is received by the processing device or the software module. The estimated position is a position in the digital map or at least can be assigned to a position in the digital map. In the present example, the estimated vehicle position corresponds to the position in the digital map at which the vehicle 105 is indicated in FIG. 1A.

The vehicle 105 is located in the left lane according to the position estimate. However, the position estimate may be subject to some uncertainty and should therefore be reliably validated in the further method steps on the basis of information provided by the LiDAR sensor 1151.

A further step 215 is the detection of a number of first features 400 in the digital map, which point to the adjacent objects 310-370 located next to the roadway. The first features are in the form of data points, which describe the objects 310-370 in total. In FIG. 1A this is illustrated schematically by a dotted representation of the objects 310-370.

It is also possible that the digital map contains the objects 310-370 primarily in the form of continuous structures, such as areas or lines, and that these structures are for further processing by sampling into a totality of individual data points.

In a further step 220, the first features 400 are grouped into a number of first feature groups 405-470. This is done in such a way that all first features 400 located in a respective area next to the roadway defined with regard to its longitudinal extent belong to a first feature group 405-470 assigned to the respective area.

Specifically, in the present exemplary embodiment, several contiguous areas are defined, each extending longitudinally along the roadway over a predetermined length L (for example 1 meter). In FIG. 1A, this is illustrated by several horizontal dashed lines, each of which borders such a strip-shaped area.

All first features 400 that are in a given area are assigned to the same first feature group 405-470. In FIG. 1A, the reference characters 405-470 refer not to the different areas per se, but to the corresponding feature groups, which contain all features 400 located in a given area.

For example, all features (data points) 400 that describe the object 340 belong to the same feature group 425 because they are all in the same strip-shaped area. In contrast, for example, the features 400 which describe the object 360 are divided into three adjacent feature groups 445, 450, 455, since they extend over three adjacent areas. Feature group 410 contains both features 400 which describes the object 320 and features 400 which describe the object 330. On the left side of the roadway, the object 310 also extends over several areas and thus feature groups, wherein only one feature group 470 is provided with a reference character here by way of example.

A further step is the reception 225 of sensor information about the vehicle environment. In the present exemplary embodiment, the sensor information is generated by way of the LiDAR sensor 1151 and transmitted to the processing device 120.

In a further step 230, which will be explained below with reference to FIG. 1B, a number of second features 500 are detected in the sensor information by way of the processing device 120. The second features 500 indicate in the present example some objects 310, 320, 330, 340, 360, 370 from the totality of objects 310-370, which are also shown in the digital map according to FIG. 1A. However, the object 350 shown in the digital map has not been detected by the LiDAR sensor 1151 in the present case. One reason for this may be, for example, that by its nature the object 350 is not detectable or only detectable with difficulty by way of LiDAR or that the object 350 is actually not present in the vehicle environment, for example because the digital map is no longer up to date in this respect.

Similar to the first features 400, the second features 500 are also present in the form of data points. For example, each individual data point 500 corresponds to a data point detected by the LiDAR sensor 1151. Each data point 500 has a unique position relative to the vehicle 105, as illustrated in FIG. 1B.

A further step 235 is to group the second features 500 into a number of second feature groups 505-570 in such a way that all second features 500 that are in a respective area next to the roadway defined with respect to its longitudinal extent belong to a second feature group 505-570 assigned to the respective area.

The grouping 235 of the second features 500 can be carried out quite analogously to the grouping 220 of the first features 400. For example, as described above with reference to the grouping 220 of the first features 400, several contiguous strip-shaped areas can be defined, each extending over a predetermined length L (for example 1 meter) along the roadway. All second features 500 located in such an area can then be assigned to a similar second feature group 505-570. As a result, several second feature groups 505-570 are created, each containing second features 500 located in the respective assigned areas.

The division into areas, each of which has a defined longitudinal boundary, is the same for the exemplary embodiment described herein as has already been used in the grouping 220 of the first features 400. As mentioned at the beginning, one can visualize the division of the first and second features 400, 500 when grouped into corresponding feature groups 405-470, 505-507 in such a way that the features 400, 500 can be placed in several buckets (corresponding to the different areas).

In a further step 240, some first and/or second feature groups 410, 425, 510, 525 are rejected, so that they are not used in the subsequent procedure steps for the validation of the estimated vehicle position.

Specifically, for example, all first feature groups 410, 425 whose maximum lateral extent exceeds a first predetermined value B1 (for example 1 meter) can be rejected.

In FIG. 1A the feature groups 410, 425 rejected based on this criterion are marked with a dark “X”. Unrejected feature groups 405, 415, 435-470 are marked with a dark checkmark. A bright “X” marks areas where there are no first features that could be used for validation of the estimated vehicle position.

For example, the features of the rejected feature group 410 belong to two different elongated objects 320, 330, which overlap in the area associated with the feature group 410 in such a way that they have a common longitudinal extent area. A maximum lateral (i.e. measured transversely to the roadway) distance of first features 400 of the two objects 320, 330 exceeds the first predetermined value B1, which causes feature group 410 to be rejected.

The rejected feature group 425 belongs to a single object 340, whose lateral extent is greater than the first predetermined value B1.

In addition or as an alternative to rejecting some first feature groups 410, 425, all second feature groups 510, 525, whose maximum lateral extent exceeds a second predetermined value B2 can also be rejected in a very similar manner. This is illustrated in FIG. 1B, where the rejected second feature groups 510, 525 are again marked with a dark “X”. The second value B2 can be identical to the first value B1.

By rejecting 240 the mentioned feature groups 410, 425, 510, 525 it can be prevented that an unwanted ambiguity arises for validation, especially of an estimated lateral position.

FIGS. 2A and 2B illustrate an embodiment variant of the rejected step 240, wherein for the purposes of rejecting 240 the first features 400 and/or the second features 500 located in an area next to the roadway defined with respect to its longitudinal extent are additionally also considered as part of those first or second feature groups 405, 415, 445-470, 505, 515, 545-570 assigned to the respective longitudinally adjacent areas. Based on this, the same criteria are then applied with regard to the lateral extent of the feature groups as described above with regard to FIGS. 1A and 1B. In this variant, for example, the first feature groups 405 and 415 as well as the corresponding second feature groups 505 and 515 are consequently rejected.

In this embodiment variant, the respective features 400, 500 for the rejecting step 240, figuratively speaking, are also placed in neighboring buckets. This makes the corresponding objects 320-370, to which the features 400, 500 refer, virtually extended so to speak. For example, if areas (buckets) with a length of 1 meter each are used, this results in a virtual longitudinal lengthening by 2 meters. In this way, for example a longitudinal measurement tolerance can be taken into account.

A further step 245 is the assignment of at least some of the unrejected first feature groups 405, 415, 445-470 to an unrejected second feature group 505, 515, 545-570. In particular, such first and second feature groups which correspond to each other, in the sense that it can be assumed that they describe the same object or the same parts of an object in the digital map or in the vehicle environment, can be assigned to each other.

In the present exemplary embodiment, the same division of the digital map or the section of the sensor-detected vehicle environment (see FIG. 1B or FIG. 2B) into longitudinally delimited areas was used when grouping 220, 235 the first or second features 400, 500 (see FIG. 1A or FIG. 2A), and the mutually assigned feature groups 405, 415, 445-470, 505, 515, 545-570 correspond to each other in the sense that they are assigned to mutually corresponding areas. For example, the first feature group 405 is assigned to the second feature group 505, the first feature group 410 is assigned to the second feature group 510, and so on.

A further step 250 is determining the validity of the estimated position of the vehicle 105 on the basis of a comparison of positions of a number of the unrejected first feature groups 405, 415, 445-470 with positions of the respective assigned second feature groups 505, 515, 545-570. The determination of the validity of the estimated position is thus carried out by comparing the positions of first features 400 which are expected based on the map information (see FIG. 1A or FIG. 2A) and the positions of second features 500 (see FIG. 1B or FIG. 2A). FIG. 2B) which are detected by way of the environment sensor system 1151.

The validity of the estimated position is determined in the exemplary embodiment according to FIG. 1A-B in such a way that, based on the assumption that the estimated position was correct, the positions of the number of the first feature groups 405, 415, 445-470 are compared with the positions of the assigned second feature groups 505, 515, 545-570 in a common coordinate system.

In the embodiment variant according to FIG. 2A-B, on the other hand, due to the modified grouping/rejecting, on the right side only the feature groups 435, 445, 450 and 465 are used for the position comparison.

It may be provided, for example, that the estimated vehicle position is confirmed if the positions of all mutually assigned feature groups 405, 415, 445-470, 505, 515, 545-570 differ by less than a predefined distance (such as 50 cm or 1 m).

For the evaluation of position deviations in the longitudinal or lateral direction, different predetermined distances may also be provided. For example, it may be provided that the estimated position is confirmed if a lateral distance between the respective mutually assigned feature groups 405, 415, 445-470, 505, 515, 545-570 is not greater than 50 cm and if a longitudinal distance between the respective mutually assigned feature groups 405, 415, 445-470, 505, 515, 545-570 is not greater than 1 meter. Obviously, this is the case from the comparison of FIGS. 1A and 1B or FIGS. 2A and 2B, so that in the present example scenario the estimated vehicle position was confirmed by the LiDAR validator.

The decision as to whether the arrangement of the mutually assigned feature groups 405, 415, 445-470, 505, 515, 545-570 matches a position estimate can also be made on the basis of a statistical analysis. For example, it may be provided that the estimated position is confirmed if the positions of at least a defined proportion (such as at least 90%) of the mutually assigned feature groups 405, 415, 445-470, 505, 515, 545-570 differ by less than a predetermined distance (if appropriate differentiated by lateral and longitudinal direction, as described above).

The statistical analysis may also take into account a statistical distance distribution. For example, it may be provided that as a prerequisite for a confirmation of the estimated position at least 60% of the considered pairs of mutually assigned first and second feature groups 405, 415, 445-470, 505, 515, 545-570 may not be further than 30 cm apart, and that at the same time at least 90% of the pairs may not be more than 60 cm apart.

The comparison of the positions of the mutually assigned feature groups 405, 415, 445-470, 505, 515, 545-570 can be carried out in each case with reference to a certain set of feature groups, which can correspond for example to a currently considered map section. Thus for example, a section extending over a length of 20-40 meters (longitudinal) along the roadway can be considered. With a defined length of the individual areas of 1 meter, this would lead to the comparison being based on a set of a maximum of 20-40 feature groups. If, for example, 90% of these feature groups agree (i.e. no further than a predetermined distance apart), the estimated position is validated.

According to an advantageous embodiment, the method 200 is carried out separately for features 400, 500, which indicate objects on different sides of the roadway. Thus in relation to the present exemplary embodiment, all method steps are carried out on the one hand for features 400, 500, which indicate the object 310 on the left edge of the roadway, and independently thereof for features 400, 500, which indicate the objects 320-370 on the right edge of the roadway.

If, for example, the objects located on the right-hand edge of the roadway 320-370 are altogether unsuitable for a position validation because too many feature groups are rejected (cf. for example FIG. 2A-B), the information about the object 310 on the left edge of the roadway can nevertheless be used in this embodiment to validate the estimated vehicle position.

1.-11. (canceled)

12. A computer-implemented method for determining a validity of an estimated position of a vehicle, the method comprising:
receiving a digital map;
receiving the estimated position of the vehicle, wherein the estimated position is a position in the digital map or is assignable to a position in the digital map;
detecting a number of first features in the digital map, wherein the first features indicate at least one object adjacent to a roadway;
grouping the first features into a number of first feature groups such that all of the first features located in a respective area next to the roadway defined with regard to a longitudinal extent of the respective area belong to a first feature group assigned to the respective area;
receiving sensor information about an environment of the vehicle;
detecting a number of second features in the sensor information, wherein the second features indicate at least one object adjacent to a roadway;
grouping the second features into a number of second feature groups such that all of the second features located in a respective area next to the roadway defined with regard to a longitudinal extent of the respective area belong to a second feature group of the respective area;
rejecting first feature groups whose maximum lateral extent exceeds a first predetermined value and/or rejecting second feature groups whose maximum lateral extent exceeds a second predetermined value;
assigning at least some unrejected first feature groups to a respective unrejected second feature group; and
determining the validity of the estimated position of the vehicle based on a comparison of positions of a number of the unrejected first feature groups with positions of the respective assigned second feature groups.

13. The method according to claim 12, wherein the validity of the estimated position is determined such that, based on an assumption that the estimated position was correct, positions of the number of the first feature groups are compared with positions of the respective assigned second feature groups in a common coordinate system.

14. The method according to claim 12, wherein the estimated position is confirmed if positions of all mutually assigned feature groups differ by less than a predetermined distance.

15. The method according to claim 12, wherein the estimated position is confirmed if positions of at least a defined proportion of the mutually assigned feature groups differ by less than a predetermined distance.

16. The method according to claim 12, wherein the sensor information is generated by a LiDAR sensor.

17. The method according to claim 12, wherein the method is carried out separately for features indicating objects on different sides of the roadway.

18. The method according to claim 12, wherein for the rejecting, the first features and/or the second features located in a respective area next to the roadway defined with regard to a longitudinal extent of the respective area are additionally considered as part of the first or second feature groups which are assigned to respective longitudinally adjacent areas.

19. The method according to claim 12, wherein each of the digital map and the sensor information also provides height information about the features, and wherein features with heights which differ by at least a predetermined height difference are not assigned to a same feature group.

20. A processing device that is configured to carry out the method according to claim 12.

21. A computer product comprising a non-transitory computer-readable memory medium having stored thereon program code which, when executed by a processing device, carries out the method according to claim 12.
